(19) United States
(12) Patent Application Publication
(10) Pub. No.: US 2019/0256098 A1
(43) Pub. Date: Aug. 22, 2019

(54) VEHICLE CONTROL DEVICE

(71) Applicant: HONDA MOTOR CO., LTD., TOKYO (JP)

(72) Inventors: Suguru YANAGIHARA, WAKO-SHI (JP); Hiroshi MIURA, WAKO-SHI (JP); Marina SAIKYO, WAKO-SHI (JP)

(21) Appl. No.: 16/276,930

(22) Filed: Feb. 15, 2019

(30) Foreign Application Priority Data
Feb. 16, 2018 (JP) 2018-026300

(51) Int. Cl. B60W 30/18; G06K 9/00; B60W 30/09; B60W 30/095; G08G 1/16

(52) U.S. Cl. CPC B60W 30/18163; B60W 30/18154; G08G 1/167; B60W 30/09; B60W 30/0956; G06K 9/00798

(57) ABSTRACT

If an external environment recognition unit recognizes a particular section (yellow lane) where an own vehicle can travel between a first travel path and a second travel path, a vehicle controller causes the own vehicle to move from the first travel path to the particular section and enter a second road from the particular section after a travel along the first travel path in the particular section. On the other hand, if the external environment recognition unit does not recognize the particular section, the vehicle controller causes the own vehicle to enter the second road from the first travel path.

### CROSS-REFERENCE TO RELATED APPLICATION

This application is based upon and claims the benefit of priority from Japanese Patent Application No. 2018-026300 filed on Feb. 16, 2018, the contents of which are incorporated herein by reference.

### BACKGROUND OF THE INVENTION

### Field of the Invention

The present invention relates to a vehicle control device that controls an own vehicle so as to enter a target area from a travel path.

### Description of the Related Art

Japanese Laid-Open Patent Publication No. 2013-149053 discloses a device that determines whether a vehicle can finish turning right at an intersection when the vehicle turns right from a first road to a second road in a region where vehicles keeps left. Specifically, this device performs the determination on the basis of remaining time of a travel permission signal for the first road and vehicle information such as the vehicle speed of the vehicle. In a place including a travel lane for turning right (in some regions, for turning left), the vehicle may turn right (in some regions, turn left) using this travel lane.

### SUMMARY OF THE INVENTION

In some regions, a road including a first travel path and a second travel path, whose traveling directions are opposite, includes a particular section (a yellow lane or a channelizing zone) between the first travel path and the second travel path. In this particular section, vehicles can travel in directions opposite to each other. In such regions, the vehicle needs to turn right or left using the particular section appropriately.

The present invention has been made in view of the above circumstances, and an object is to provide a vehicle control device that enables a vehicle to turn left or right appropriately in a place including a particular section.

A vehicle control device according to the present invention includes: an external environment recognition unit configured to recognize a peripheral state of an own vehicle; and a vehicle controller configured to perform travel control of the own vehicle on a basis of a recognition result from the external environment recognition unit, wherein when the own vehicle traveling in a first travel path of a road including the first travel path and a second travel path in which vehicles travel in opposite directions, enters a target area on a second travel path side from the first travel path by crossing the second travel path, if the external environment recognition unit recognizes a particular section where the own vehicle can travel between the first travel path and the second travel path, the vehicle controller is configured to cause the own vehicle to move from the first travel path to the particular section and enter the target area from the particular section after a travel along the first travel path in the particular section, and if the external environment recognition unit does not recognize the particular section, the vehicle controller is configured to cause the own vehicle to enter the target area from the first travel path.

The above structure causes the own vehicle to move from the first travel path to the particular section and enter the target area after the travel along the first travel path. Therefore, in the place including the particular section, the traveling direction of the own vehicle can be changed (own vehicle can turn right or left) appropriately using the particular section.

In the present invention, if the external environment recognition unit recognizes the particular section, the vehicle controller may be configured to cause the own vehicle to move to a position in the particular section that is distant from the target area by a predetermined distance to an own vehicle side, or move to the particular section at a time point before an expected arrival time to the target area by a predetermined time.

In the above structure, when the traveling distance or the traveling time in the particular section is set, the traveling direction of the own vehicle can be changed (own vehicle can turn right or left) in accordance with the setting.

In the present invention, the vehicle controller may be configured to perform speed control to cause the own vehicle to travel in the particular section before the own vehicle moves from the first travel path to the particular section.

When the own vehicle moves to the particular section and decelerates concurrently, the deceleration and lateral acceleration occur at the same time in the own vehicle. Therefore, an occupant may feel uncomfortable about the operation of the own vehicle. The above structure performs the speed control of the own vehicle, for example, the deceleration control in advance before causing the own vehicle to move to the particular section. Thus, it is not necessary to cause the own vehicle to move to the particular section and decelerate concurrently. Therefore, the occupant does not feel uncomfortable about the operation of the own vehicle.

In the present invention: the predetermined distance may be a first predetermined distance; a second predetermined distance that is longer than the first predetermined distance may be set; the predetermined time may be a first predetermined time; a second predetermined time that is longer than the first predetermined time may be set; and if the external environment recognition unit recognizes another vehicle in the particular section, the vehicle controller may be configured to perform speed control considering the other vehicle, from a position that is distant from the target area by the second predetermined distance to the own vehicle side, or a position where the own vehicle travels before the expected arrival time to the target area by the second predetermined time.

In the above structure, the speed control considering the other vehicle is performed. Thus, the own vehicle can smoothly travel after moving to the particular section.

In the present invention, if the external environment recognition unit recognizes an obstacle at a position that is distant from the target area by the predetermined distance to the own vehicle side or a position where the own vehicle travels before the expected arrival time to the target area by the predetermined time, the vehicle controller may be configured to cause the own vehicle to move from the first travel path to the particular section after the own vehicle passes the obstacle.

In the above structure, even if the obstacle exists in the particular section, the own vehicle can travel in the particular section.

In the present invention, if the external environment recognition unit recognizes a traffic jam at a position that is distant from the target area by the predetermined distance to the own vehicle side, the vehicle controller may be configured to turn on a blinker on a particular section side before the own vehicle reaches the position.

In the above structure, a behavior of the own vehicle can be recognized by the surrounding vehicles etc. of the own vehicle.

By the present invention, in the place including the particular section, the traveling direction of the own vehicle can be changed (own vehicle can turn right or left) appropriately using the particular section.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram of a vehicle including a vehicle control device according to one embodiment;

FIG. 2 is a function block diagram of a calculation device;

FIG. 3 is a diagram illustrating a travel trajectory generated when an own vehicle enters a second road by turning left from a first travel path in a scene where a particular section is provided between the first travel path and a second travel path;

FIG. 4 is a diagram illustrating a travel trajectory generated when the own vehicle enters the second road by turning left from the first travel path in a scene where the particular section is provided and an obstacle exists between the first travel path and the second travel path;

FIG. 5 is a diagram illustrating a travel trajectory generated when the own vehicle enters the second road by turning left from the first travel path in a scene where the particular section is not provided between the first travel path and the second travel path;

FIG. 6 is a flowchart of a main process performed by the vehicle control device according to the present embodiment; and

FIG. 7 is a flow chart of a movement preparation process.

### DESCRIPTION OF THE PREFERRED EMBODIMENTS

A preferred embodiment of a vehicle control device according to the present invention will be described in detail with reference to the attached drawings.

### [1. Structure of Own Vehicle 10]

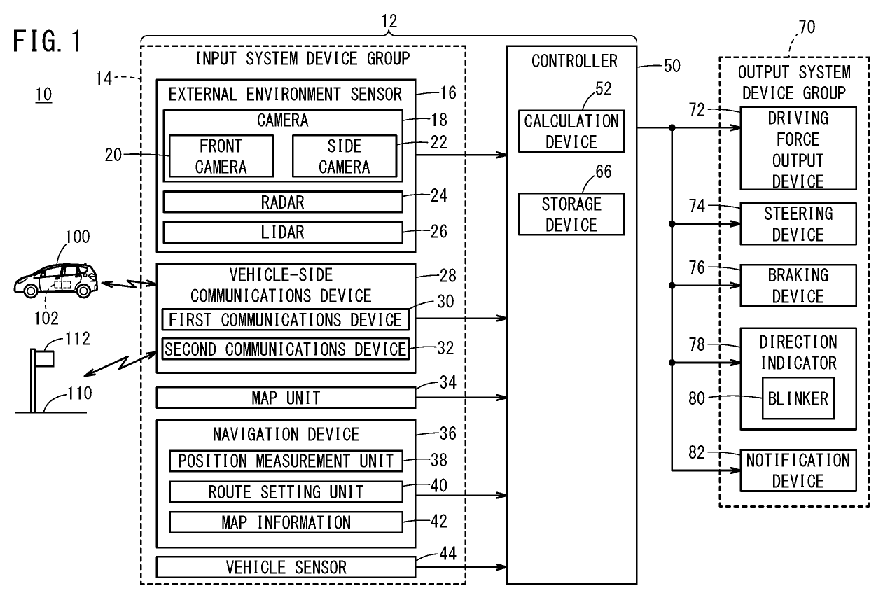

As illustrated in FIG. 1, an own vehicle 10 includes an input system device group 14 that acquires or stores various kinds of information, a controller 50 to which information output from the input system device group 14 is input, and an output system device group 70 that operates in accordance with various instructions output from the controller 50. A vehicle control device 12 according to the present embodiment includes the input system device group 14 and the controller 50. The own vehicle 10 is an automated driving vehicle in which travel control is performed by the controller 50 (including fully automated driving vehicle) or a driving assistance vehicle in which travel control is assisted partially.

### [1.1. Input System Device Group 14]

The input system device group 14 includes an external environment sensor 16, a vehicle-side communications device 28, a map unit 34, a navigation device 36, and vehicle sensors 44. The external environment sensor 16 detects a state of a periphery (external environment) of the own vehicle 10. The external environment sensor 16 includes a plurality of cameras 18 that photographs the external environment, a plurality of radars 24 and one or more LIDARs 26 that detect the distance and the relative speed between the own vehicle 10 and peripheral objects. The cameras 18 include a front camera 20 that photographs an area ahead of the own vehicle 10, and a side camera 22 that photographs a side area of the own vehicle 10. The vehicle-side communications device 28 includes a first communications device 30 and a second communications device 32. The first communications device 30 performs inter-vehicle communications with a communications device 102 provided to another vehicle 100 to acquire external environment information including information regarding the other vehicle 100 (such as a vehicle type, a travel state, or a travel position). The second communications device 32 performs road-vehicle communications with a road-side communications device 112 provided to an infrastructure such as a road 110 to acquire external environment information including the road information (such as information regarding a traffic light or a traffic jam). The map unit 34 stores the number of lanes, the type of lane, the lane width, and the like. The navigation device 36 includes a position measurement unit 38 that measures the position of the own vehicle 10 by a satellite navigation method and/or a self-contained navigation method, map information 42, and a route setting unit 40 that sets a scheduled route from the position of the own vehicle 10 to a destination on the basis of the map information 42. The vehicle sensors 44 detect the travel state of the own vehicle 10. The vehicle sensors 44 include a vehicle speed sensor, an acceleration sensor, a yaw rate sensor, an inclination sensor, a travel distance sensor, and the like, that are not shown.

### [1.2. Output System Device Group 70]

The output system device group 70 includes a driving force output device 72, a steering device 74, a braking device 76, a direction indicator 78, and a notification device 82. The driving force output device 72 includes a driving force output ECU, and a driving source such as an engine or a driving motor. The driving force output device 72 generates driving force in accordance with an occupant's operation of an accelerator pedal or a driving control instruction that is output from the controller 50. The steering device 74 includes an electric power steering system (EPS) ECU and an EPS actuator. The steering device 74 generates a steering force in accordance with an occupant's operation of a steering wheel or a steering control instruction that is output from the controller 50. The braking device 76 includes a braking ECU and a braking actuator. The braking device 76 generates a braking force in accordance with an occupant's operation of a braking pedal or a braking control instruction that is output from the controller 50. The direction indicator 78 includes a blinker ECU and a blinker 80. The direction indicator 78 turns on or off the blinker 80 in accordance with an occupant's operation of a blinker switch and/or an instruction signal for the blinker 80 that is output from the controller 50. The notification device 82 includes a notification ECU and an information transmission device (such as a display device, an acoustic device, or a tactile device). The notification device 82 notifies an occupant in accordance with a notification instruction that is output from the controller 50 or another ECU.

### [1.3. Controller 50]

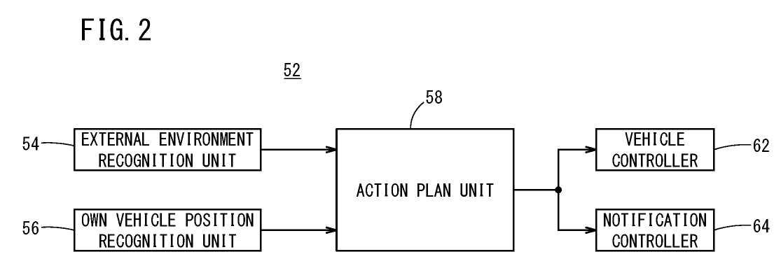

The controller 50 is configured by an ECU, and includes a calculation device 52 such as a processor and a storage device 66 such as a ROM or a RAM. The controller 50 achieves various functions when the calculation device 52 executes programs stored in the storage device 66. As illustrated in FIG. 2, the calculation device 52 functions as an external environment recognition unit 54, an own vehicle position recognition unit 56, an action plan unit 58, a vehicle controller 62, and a notification controller 64.

The external environment recognition unit 54 recognizes the periphery of the own vehicle 10 on the basis of the information output from the external environment sensor 16, the vehicle-side communications device 28, the map unit 34, and the navigation device 36. For example, the external environment recognition unit 54 recognizes the existence, position, size, type, and traveling direction of the other vehicle 100 that travels or stops near the own vehicle 10 and moreover recognizes the distance and the relative speed between the own vehicle 10 and the other vehicle 100, on the basis of image information acquired by the cameras 18, information acquired by the radars 24 and the LIDARs 26, and the external environment information acquired by the first communications device 30. In addition, the external environment recognition unit 54 recognizes the shape and the position of a recognition object included in the road environment (such as the road 110, a lane mark 126, a median strip, or facility or space near the road) on the basis of the image information acquired by the cameras 18, the information acquired by the radars 24 and the LIDARs 26, a high-precision map stored in the map unit 34, the map information 42 stored in the navigation device 36, and the external environment information acquired by the second communications device 32. The external environment recognition unit 54 recognizes a signal of a traffic light (whether travel is allowed or prohibited) on the basis of the image information acquired by the cameras 18 and the external environment information acquired by the second communications device 32.

The own vehicle position recognition unit 56 recognizes the position of the own vehicle 10 on the basis of the information output from the map unit 34 and the navigation device 36.

The action plan unit 58 plans an action that is optimal to the own vehicle 10 on the basis of a recognition result from the external environment recognition unit 54 and the own vehicle position recognition unit 56, and the detected information and stored information of the input system device group 14. For example, the action plan unit 58 plans a behavior of the own vehicle 10 at each time point, and generates a target travel trajectory and a target speed for achieving the behavior. If a scheduled route is set, the action plan unit 58 plans the action to cause the own vehicle 10 to reach the destination along the scheduled route, and if the scheduled route is not set, the action plan unit 58 plans the action to cause the own vehicle 10 to travel following the current road. Also, the action plan unit 58 plans the action other than the travel control, such as the content of the notification to the occupant, the timing of the notification, and the timing of operating the blinker 80.

The vehicle controller 62 controls the output system device group 70 on the basis of the action planned by the action plan unit 58. For example, the vehicle controller 62 calculates a steering instruction value based on the target travel trajectory generated by the action plan unit 58, and an acceleration/deceleration instruction value based on the target speed, and outputs control instructions to the driving force output device 72, the steering device 74, and the braking device 76. The vehicle controller 62 outputs the instruction of operating the blinker 80 to the direction indicator 78 before the steering.

The notification controller 64 outputs the notification instruction to the notification device 82 on the basis of a notification action planned by the action plan unit 58.

The storage device 66 illustrated in FIG. 1 stores numerals such as thresholds used in comparison, determination, or the like in each process, in addition to various programs to be executed by the calculation device 52. For example, the storage device 66 stores a first predetermined distance D1 expressing a distance by which the own vehicle 10 should travel in a yellow lane 128Y, and a second predetermined distance D2 that is longer than the first predetermined distance D1.

### [2. Circumstances Assumed in the Present Embodiment]

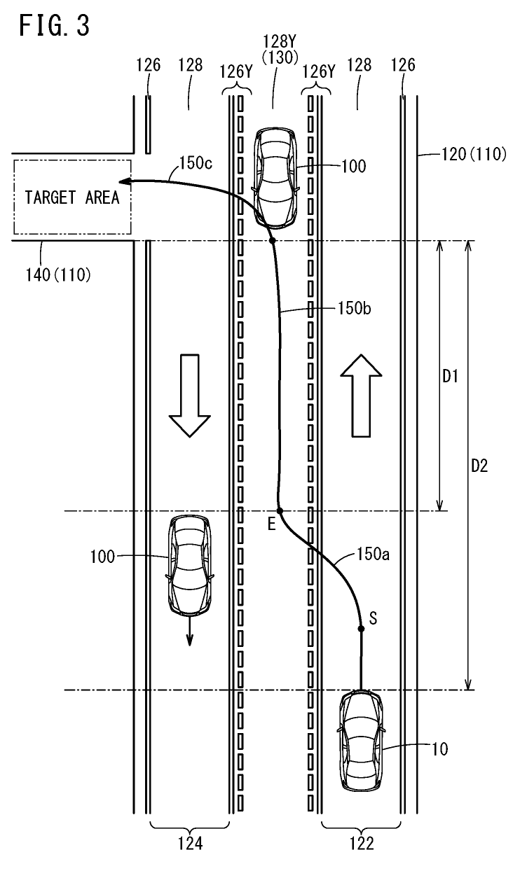

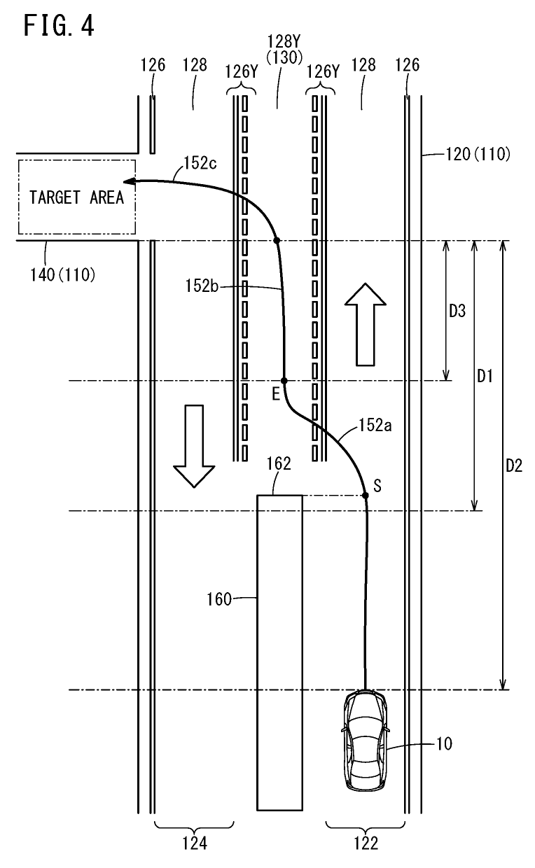

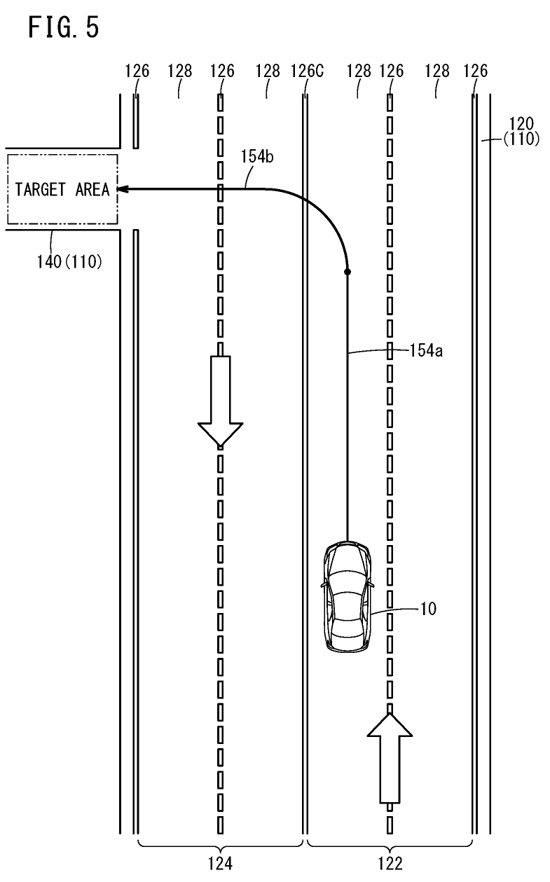

FIG. 3 to FIG. 5 illustrate circumstances that are assumed in the present embodiment. In the road 110 illustrated in FIG. 3 to FIG. 5, vehicles keep to the right. As illustrated in FIG. 3 to FIG. 5, a first road 120 includes a first travel path 122 and a second travel path 124 in which vehicles travel in opposite (counter) directions. On the second travel path 124 side of the first road 120, there is a second road 140 (target area) intersecting with the first road 120. The first road 120 is a main road, while the second road 140 is a side road. Between the first travel path 122 and the second travel path 124 in the first road 120 in FIG. 3 and FIG. 4, a particular section 130 that is adjacent to both travel paths is provided, and the particular section 130 is not provided to the first road 120 in FIG. 5. The particular section 130 in FIG. 3 and FIG. 4 is the yellow lane 128Y that is sectioned on both sides in a width direction by two-line lane marks 126Y each including a yellow solid line and a yellow dashed line. The yellow lane 128Y is a travel lane 128 that is provided in the road 110 in U.S.A., for example, and allows vehicles to travel in opposite directions. When a vehicle in the first travel path 122 enters an area on the second travel path 124 side (second road 140, etc.) by turning left, the vehicle moves to the yellow lane 128Y and travels in the yellow lane 128Y before turning left. When a vehicle in the second travel path 124 enters an area on the first travel path 122 side by turning left, the vehicle turns left by using the yellow lane 128Y similarly. In addition, when a vehicle in the second road 140 enters the first travel path 122 by turning left, the vehicle enters the yellow lane 128Y and travels in the yellow lane 128Y before moving to the travel lane 128 of the first travel path 122. FIG. 3 to FIG. 5 show travel trajectories 150a to 150c, 152a to 152c, 154a, 154b that are generated when the own vehicle 10 in the first travel path 122 of the first road 120 enters the second road 140 by turning left.

### [3. Operation of Vehicle Control Device 12]

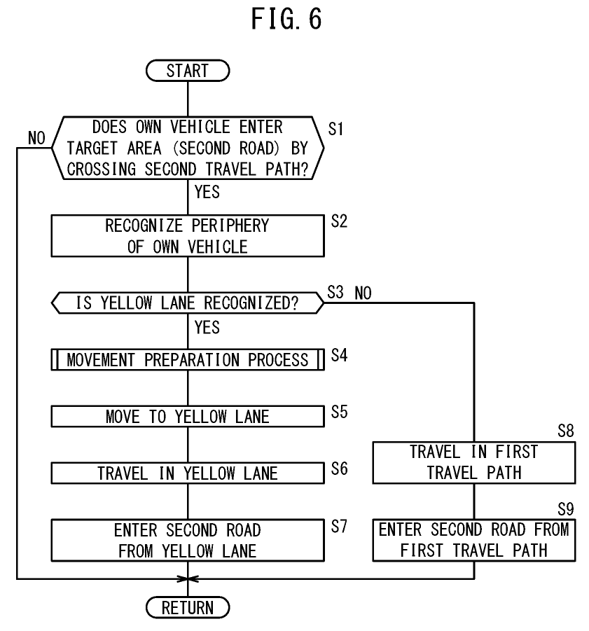

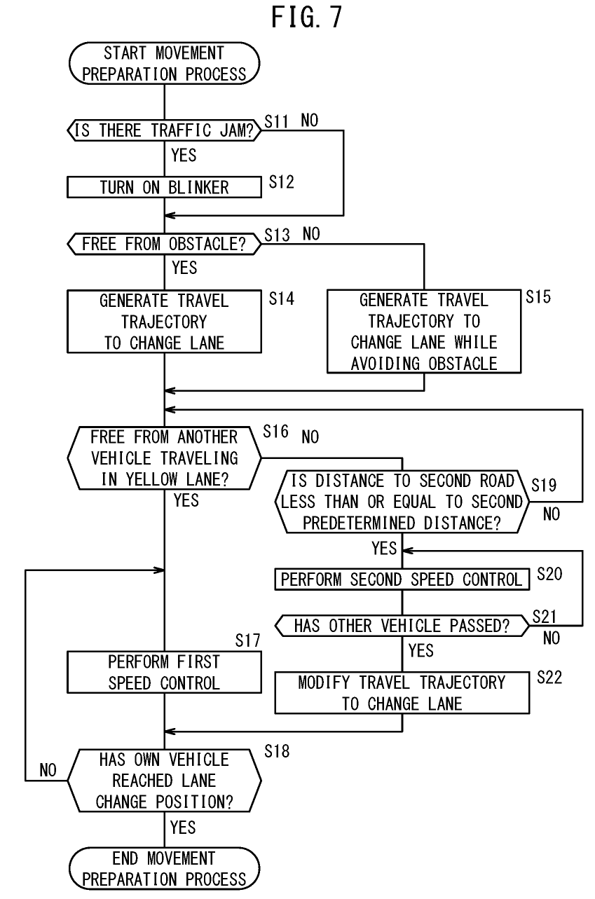

An operation of the vehicle control device 12 is described with reference to FIG. 6 and FIG. 7.

### [3. 1. Main Process]

In step S1 of a main process in FIG. 6, the action plan unit 58 determines an event that is generated in the own vehicle 10 on the basis of the position of the own vehicle 10 that is recognized by the own vehicle position recognition unit 56, the map information 42 or the information of the map unit 34, and the scheduled route. As illustrated in FIG. 3 to FIG. 5, when the own vehicle 10 traveling on the first travel path 122 has approached the second road 140, an event of traveling straight on the first travel path 122 or entering the second road 140 is generated. If the own vehicle 10 enters the second road 140 by crossing the second travel path 124 (step S1: YES), the process advances to step S2. On the other hand, if the own vehicle 10 does not enter the second road 140 (step S1: NO), a series of processes in FIG. 6 is terminated once.

In step S2, the external environment recognition unit 54 recognizes the periphery of the own vehicle 10, i.e., in this case, meaning each travel lane 128 included in the first road 120, on the basis of the latest information output from the input system device group 14. For example, the external environment recognition unit 54 can recognize each travel lane 128 included in the first road 120 on the basis of the map information 42 or the information of the map unit 34.

In addition, the external environment recognition unit 54 can recognize each travel lane 128 included in the first road 120 on the basis of the image information acquired by the cameras 18. In this case, the external environment recognition unit 54 recognizes the lane mark 126 (including the yellow lane mark 126Y, a center line 126C) on the basis of the image information. If the travel lane 128 that is sectioned on both sides by the yellow lane marks 126Y or the two-line lane marks 126Y each consisting of the inner dashed line and the outer solid line is recognized at a center of the first road 120, this travel lane 128 is recognized as the yellow lane 128Y.

In the case where the yellow lane 128Y exists between the second road 140 and the own vehicle 10 as illustrated in FIG. 3 and FIG. 4, the external environment recognition unit 54 recognizes the yellow lane 128Y. In this case (step S3: YES), the process advances to step S4. On the other hand, in the case where the yellow lane 128Y does not exist between the second road 140 and the own vehicle 10 as illustrated in FIG. 5, the external environment recognition unit 54 does not recognize the yellow lane 128Y. In this case (step S3: NO), the process advances to step S8.

When the process has advanced from step S3 to step S4, a movement preparation process illustrated in FIG. 7 is performed. The movement preparation process includes predetermined determinations and processes that are performed before the own vehicle 10 moves to the yellow lane 128Y. The determinations and the processes in the movement preparation process can be set freely. In the movement preparation process according to the present embodiment, the target speed, and the travel trajectory 150a (FIG. 3) and the travel trajectory 152a (FIG. 4) to change the lane from the first travel path 122 to the yellow lane 128Y are generated. The movement preparation process will be described in [3. 2].

After the movement preparation process ends, the vehicle controller 62 causes the own vehicle 10 to move from the first travel path 122 to the yellow lane 128Y in step S5. That is to say, the vehicle controller 62 causes the own vehicle 10 to travel along the travel trajectories 150a, 152a generated in the movement preparation process. In this case, the vehicle controller 62 keeps the vehicle speed substantially the same. The driving force output device 72 and the braking device 76 operate in accordance with a speed keeping instruction that is output from the vehicle controller 62. Moreover, the steering device 74 operates in accordance with a steering instruction that is output from the vehicle controller 62.

In step S6, the vehicle controller 62 causes the own vehicle 10 to travel in the yellow lane 128Y. That is to say, the action plan unit 58 generates the target speed and the travel trajectories 150b, 152b (FIG. 3, FIG. 4) that cause the own vehicle 10 to travel in the yellow lane 128Y toward the second road 140. The vehicle controller 62 causes the own vehicle 10 to travel along the travel trajectories 150b, 152b, and controls acceleration/deceleration in accordance with the target speed. The driving force output device 72 and the braking device 76 operate in accordance with an acceleration/deceleration instruction that is output from the vehicle controller 62. Then, as illustrated in FIG. 3, the own vehicle 10 travels in the yellow lane 128Y by the first predetermined distance D1. As illustrated in FIG. 4, if there is an obstacle 160 (for example, another vehicle 100 or road structure such as a median strip) in the first road 120, the own vehicle 10 travels in the yellow lane 128Y by a third predetermined distance D3 (<D1).

In step S7, the vehicle controller 62 causes the own vehicle 10 to enter the second road 140 from the yellow lane 128Y. That is to say, the action plan unit 58 generates the target speed, and the travel trajectory 150c (FIG. 3) and the travel trajectory 152c (FIG. 4) that cause the own vehicle 10 to enter the second road 140 from the yellow lane 128Y. The vehicle controller 62 causes the own vehicle 10 to travel along the travel trajectories 150c, 152c, and controls the acceleration/deceleration in accordance with the target speed. The driving force output device 72 and the braking device 76 operate in accordance with the acceleration/deceleration instruction that is output from the vehicle controller 62. Moreover, the steering device 74 operates in accordance with the steering instruction that is output from the vehicle controller 62.

When the process has advanced from step S3 to step S8, the vehicle controller 62 causes the own vehicle 10 to travel in the first travel path 122. That is to say, the action plan unit 58 generates the target speed and the travel trajectory 154a (FIG. 5) that causes the own vehicle 10 to travel in the first travel path 122 toward the second road 140. The vehicle controller 62 causes the own vehicle 10 to travel along the travel trajectory 154a, and controls the acceleration/deceleration in accordance with the target speed. The driving force output device 72 and the braking device 76 operate in accordance with the acceleration/deceleration instruction that is output from the vehicle controller 62.

In step S9, the vehicle controller 62 causes the own vehicle 10 to enter the second road 140 from the first travel path 122. That is to say, the action plan unit 58 generates the target speed and the travel trajectory 154b (FIG. 5) that causes the own vehicle 10 to enter the second road 140 from the first travel path 122. The vehicle controller 62 causes the own vehicle 10 to travel along the travel trajectory 154b, and controls the acceleration/deceleration in accordance with the target speed. The driving force output device 72 and the braking device 76 operate in accordance with the acceleration/deceleration instruction that is output from the vehicle controller 62. Moreover, the steering device 74 operates in accordance with the steering instruction that is output from the vehicle controller 62.

### [3. 2. Movement Preparation Process]

When the process has advanced from step S3 to step S4 in FIG. 6, a series of processes illustrated in FIG. 7 is performed. In step S11, the external environment recognition unit 54 determines whether there is a traffic jam at a position in the first travel path 122 that is distant from the second road 140 by the first predetermined distance D1 to the own vehicle 10 side on the basis of the image information or the external environment information acquired by the second communications device 32. If there is a traffic jam (step S11: YES), the process advances to step S12. On the other hand, if there is not a traffic jam (step S11: NO), the process advances to step S13.

When the process has advanced from step S11 to step S12, the action plan unit 58 plans the action in which the blinker 80 on the yellow lane 128Y side, that is, on the left side is turned on from a position that is distant from the second road 140 by more than the first predetermined distance D1 to the own vehicle 10 side. The vehicle controller 62 outputs a lighting instruction for turning on the blinker 80 to the direction indicator 78 at a predetermined timing that is determined by the action plan unit 58. The direction indicator 78 turns on the blinker 80 in accordance with the lightning instruction.

In step S13, the external environment recognition unit 54 recognizes whether the obstacle 160 exists at the position that is distant from the second road 140 by the first predetermined distance D1 to the own vehicle 10 side, on the basis of at least one piece of information of the image information, the high-precision map stored in the map unit 34, and the map information 42. If the position is free from the obstacle 160 (step S13: YES), the process advances to step S14. On the other hand, if the obstacle 160 exists (i.e., not free from the obstacle 160) (step S13: NO), the process advances to step S15.

When the process has advanced from step S13 to step S14, the action plan unit 58 generates the target speed and the travel trajectory 150a (FIG. 3) to change the lane from the first travel path 122 to the yellow lane 128Y. A start point S of the travel trajectory 150a is set ahead of the own vehicle 10 and at an approximately central position in the first travel path 122. An end point E of the travel trajectory 150a is set at a position distant from the second road 140 by the first predetermined distance D1 to the own vehicle 10 side and at an approximately central position in the yellow lane 128Y.

When the process has advanced from step S13 to step S15, the action plan unit 58 generates the target speed and the travel trajectory 152b (FIG. 4) to change the lane from the first travel path 122 to the yellow lane 128Y. The start point S of the travel trajectory 152a is set at a position on an extending border line 162 between the obstacle 160 and the yellow lane 128Y and at the approximately central position in the first travel path 122. The end point E of the travel trajectory 152a is set on the own vehicle 10 side as compared to the second road 140 and at the central position in the yellow lane 128Y.

When the process has advanced from step S14 or step S15 to step S16, the external environment recognition unit 54 recognizes whether there is another vehicle 100 traveling in the yellow lane 128Y toward the own vehicle 10. If no other vehicle 100 is traveling in the yellow lane 128Y (step S16: YES), the process advances to step S17. On the other hand, if the other vehicle 100 is traveling in the yellow lane 128Y (step S16: NO), the process advances to step S19.

When the process has advanced from step S16 to step S17, the action plan unit 58 plans to perform first speed control. The first speed control is speed control that causes the own vehicle 10 to travel in the yellow lane 128Y. Here, the action plan unit 58 uses the target speed, which is to be reached at the end point E of the travel trajectories 150a, 152a, as the target speed at the start point S of the travel trajectories 150a, 152a. At the start point S of the travel trajectories 150a, 152a, the vehicle controller 62 calculates acceleration/deceleration required for causing the own vehicle 10 to travel at the target speed. The driving force output device 72 and the braking device 76 operate in accordance with the acceleration/deceleration instruction that is output from the vehicle controller 62.

In step S18, the own vehicle position recognition unit 56 determines whether the own vehicle 10 has reached the position of the start point S of the travel trajectories 150a, 152a, that is, a lane change position to the yellow lane 128Y. If the own vehicle 10 has reached the lane change position (step S18: YES), the movement preparation process ends. On the other hand, if the own vehicle 10 has not reached the lane change position (step S18: NO), the process returns to step S17.

When the process has advanced from step S16 to step S19, the action plan unit 58 determines whether a distance D from the own vehicle 10 to the second road 140 is less than or equal to the second predetermined distance D2. If the distance D is less than or equal to the second predetermined distance D2 (step S19: YES), the process advances to step S20. On the other hand, if the distance D is larger than the second predetermined distance D2 (step S19: NO), the process returns to step S16.

When the process has advanced from step S19 to step S20, the action plan unit 58 plans to perform second speed control. The second speed control is speed control considering the other vehicle 100 that travels in the yellow lane 128Y. Here, the action plan unit 58 plans the speed control in which the own vehicle 10 is stopped or decelerated with predetermined deceleration until the other vehicle 100 passes the yellow lane 128Y ahead of the own vehicle 10, for example. In this case, the action plan unit 58 sets the target speed in accordance with the relative position and the relative speed between the other vehicle 100 and the own vehicle 10. The vehicle controller 62 calculates the acceleration/deceleration required for causing the own vehicle 10 to travel at the target speed. The driving force output device 72 and the braking device 76 operate in accordance with a deceleration instruction that is output from the vehicle controller 62.

In step S21, the external environment recognition unit 54 recognizes whether the other vehicle 100 has passed the yellow lane 128Y ahead of the own vehicle 10. If the other vehicle 100 has passed the yellow lane 128Y (step S21: YES), the process advances to step S22. On the other hand, if the other vehicle 100 has not passed the yellow lane 128Y ahead of the own vehicle 10 (step S21: NO), the process returns to step S20.

When the process has advanced from the step S21 to step S22, the action plan unit 58 modifies the travel trajectory 150a (FIG. 3) and the target speed. After that, the process advances to step S18.

### [4. Modifications]

In the above embodiment, the own vehicle 10 travels in the yellow lane 128Y by the first predetermined distance D1 as illustrated in FIG. 3. Alternatively, the own vehicle 10 may travel in the yellow lane 128Y for a first predetermined time. In this case, the action plan unit 58 calculates an expected arrival time when the own vehicle 10 is expected to arrive at a turning-left start position, on the basis of the vehicle speed (predetermined value) or the deceleration (predetermined value) of the own vehicle 10 in the yellow lane 128Y. Then, the action plan unit 58 plans the action in which the own vehicle 10 moves to the yellow lane 128Y at a time point before the expected arrival time by the first predetermined time. The vehicle controller 62 outputs the acceleration/deceleration instruction and the steering instruction required for causing the own vehicle 10 to move from the first travel path 122 to the yellow lane 128Y in accordance with the plan from the action plan unit 58.

The external environment recognition unit 54 may recognize the obstacle 160 at a position where the own vehicle 10 travels at the time point before the expected arrival time by the first predetermined time. In this case, the action plan unit 58 plans the action in which the own vehicle 10 moves from the first travel path 122 to the yellow lane 128Y after passing the border line 162 between the obstacle 160 and the yellow lane 128Y. The vehicle controller 62 outputs the acceleration/deceleration instruction and the steering instruction required for causing the own vehicle 10 to move from the first travel path 122 to the yellow lane 128Y in accordance with the plan from the action plan unit 58.

In the above embodiment, if the distance D from the own vehicle 10 to the second road 140 becomes less than or equal to the second predetermined distance D2 (step S19: YES), the second speed control is started. Alternatively, the second speed control may be started from a position where the own vehicle 10 travels before the expected arrival time to the second road 140 by a second predetermined time. In this case, the second predetermined time is longer than the first predetermined time described above.

The particular section 130 may be other section than the yellow lane 128Y. For example, the particular section 130 may be a channelizing zone (marking) provided on the road 110 in Japan etc. In this case, the external environment recognition unit 54 recognizes the presence or absence of a zone having a stripe pattern surrounded by a white solid line (called a “zebra zone”).

In the above embodiment, the present invention is applied to a scene where the target area is the second road 140 and the vehicle in the first travel path 122 enters the second road 140 by crossing the second travel path 124. Additionally, the present invention is also applicable to a scene where the target area is a parking lot or the like beside the second travel path 124 and the vehicle in the first travel path 122 enters the parking lot or the like by crossing the second travel path 124.

In some cases, the external environment information acquired by the vehicle-side communications device 28 includes the information indicating the presence or absence of the yellow lane 128Y but excludes the detailed positional information. In such cases, the action plan unit 58 may assume that the yellow lane 128Y exists in the first road 120 on the basis of the external environment information, and generate the virtual yellow lane 128Y before performing various controls.

### [5. Summary of the Present Embodiment and Modifications]

The vehicle control device 12 includes the external environment recognition unit 54 configured to recognize the peripheral state of the own vehicle 10; the vehicle controller 62 configured to perform the travel control of the own vehicle 10 on the basis of the recognition result from the external environment recognition unit 54. When the own vehicle 10 traveling in the first travel path 122 of the first road 120 including the first travel path 122 and the second travel path 124 in which vehicles travel in opposite directions enters the second road 140 (target area) on the second travel path 124 side from the first travel path 122 by crossing the second travel path 124, the vehicle controller 62 performs the following process. That is to say, if the external environment recognition unit 54 recognizes the particular section 130 (yellow lane 128Y) where the own vehicle 10 can travel between the first travel path 122 and the second travel path 124, the vehicle controller 62 is configured to cause the own vehicle 10 to move from the first travel path 122 to the particular section 130 and enter the second road 140 from the particular section 130 after the travel along the first travel path 122 in the particular section 130. On the other hand, if the external environment recognition unit 54 does not recognize the particular section 130, the vehicle controller 62 is configured to cause the own vehicle 10 to enter the second road 140 from the first travel path 122.

The above structure causes the own vehicle 10 to move from the first travel path 122 to the particular section 130 and enter the second road 140 after the travel along the first travel path 122. Therefore, in the place including the particular section 130, the traveling direction of the own vehicle 10 can be changed (own vehicle 10 can turn right or left) appropriately using the particular section 130.

If the external environment recognition unit 54 recognizes the particular section 130, the vehicle controller 62 is configured to cause the own vehicle 10 to move to the position in the particular section 130 that is distant from the second road 140 by the first predetermined distance D1 to the own vehicle 10 side. Alternatively, the vehicle controller 62 is configured to cause the own vehicle 10 to move to the particular section 130 at the time point before the expected arrival time to the second road 140 by the predetermined time.

In the above structure, when the traveling distance or the traveling time in the particular section 130 is set, the traveling direction of the own vehicle 10 can be changed (own vehicle 10 can turn right or left) in accordance with the setting.

The vehicle controller 62 is configured to perform the speed control to cause the own vehicle 10 to travel in the particular section 130 before the own vehicle 10 moves from the first travel path 122 to the particular section 130.

When the own vehicle 10 moves to the particular section 130 and decelerates concurrently, the deceleration and lateral acceleration occur at the same time in the own vehicle 10. Therefore, an occupant may feel uncomfortable about the operation of the own vehicle 10. The above structure performs the speed control of the own vehicle 10, for example, the deceleration control in advance before causing the own vehicle 10 to move to the particular section 130. Thus, it is not necessary to cause the own vehicle 10 to move to the particular section 130 and decelerate concurrently. Therefore, the occupant does not feel uncomfortable about the operation of the own vehicle 10.

If the external environment recognition unit 54 recognizes the other vehicle 100 in the particular section 130, the vehicle controller 62 is configured to perform the speed control considering the other vehicle 100, from the position that is distant from the second road 140 by the second predetermined distance D2 to the own vehicle side, or the position where the own vehicle 10 travels before the expected arrival time to the second road 140 by the second predetermined time.

In the above structure, the speed control considering the other vehicle 100 is performed. Thus, the own vehicle 10 can smoothly travel after moving to the particular section 130.

If the external environment recognition unit 54 recognizes the obstacle 160 at the position that is distant from the second road 140 by the first predetermined distance D1 to the own vehicle 10 side or the position where the own vehicle 10 travels before the expected arrival time to the second road 140 by the predetermined time, the vehicle controller 62 is configured to cause the own vehicle 10 to move from the first travel path 122 to the particular section 130 after the own vehicle 10 passes the obstacle 160.

In the above structure, even if the obstacle 160 exists in the particular section 130, the own vehicle 10 can travel in the particular section 130.

If the external environment recognition unit 54 recognizes a traffic jam at the position that is distant from the second road 140 by the first predetermined distance D1 to the own vehicle side, the vehicle controller 62 is configured to turn on the blinker 80 on the particular section 130 side before the own vehicle 10 reaches the position.

In the above structure, the behavior of the own vehicle 10 can be recognized by the surrounding vehicles etc. of the own vehicle.

The present invention is not limited to the embodiment above, and can employ various structures without departing from the gist of the present invention.

What is claimed is:

1. A vehicle control device comprising:
an external environment recognition unit configured to recognize a peripheral state of an own vehicle; and
a vehicle controller configured to perform travel control of the own vehicle on a basis of a recognition result from the external environment recognition unit,
wherein when the own vehicle traveling in a first travel path of a road including the first travel path and a second travel path in which vehicles travel in opposite directions, enters a target area on a second travel path side from the first travel path by crossing the second travel path, if the external environment recognition unit recognizes a particular section where the own vehicle can travel between the first travel path and the second travel path, the vehicle controller is configured to cause the own vehicle to move from the first travel path to the particular section and enter the target area from the particular section after a travel along the first travel path in the particular section, and
the external environment recognition unit does not recognize the particular section, the vehicle controller is configured to cause the own vehicle to enter the target area from the first travel path.

2. The vehicle control device according to claim 1, wherein if the external environment recognition unit recognizes the particular section, the vehicle controller is configured to cause the own vehicle to move to a position in the particular section that is distant from the target area by a predetermined distance to an own vehicle side, or move to the particular section at a time point before an expected arrival time to the target area by a predetermined time.

3. The vehicle control device according to claim 2, wherein the vehicle controller is configured to perform speed control to cause the own vehicle to travel in the particular section before the own vehicle moves from the first travel path to the particular section.

4. The vehicle control device according to claim 2, wherein:
the predetermined distance is a first predetermined distance;
second predetermined distance that is longer than the first predetermined distance is set;
the predetermined time is a first predetermined time;
a second predetermined time that is longer than the first predetermined time is set; and
if the external environment recognition unit recognizes another vehicle in the particular section, the vehicle controller is configured to perform speed control considering the other vehicle, from a position that is distant from the target area by the second predetermined distance to the own vehicle side, or a position where the own vehicle travels before the expected arrival time to the target area by the second predetermined time.

5. The vehicle control device according to claim 2, wherein if the external environment recognition unit recognizes an obstacle at a position that is distant from the target area by the predetermined distance to the own vehicle side or a position where the own vehicle travels before the expected arrival time to the target area by the predetermined time, the vehicle controller is configured to cause the own vehicle to move from the first travel path to the particular section after the own vehicle passes the obstacle.

6. The vehicle control device according to claim 2, wherein if the external environment recognition unit recognizes a traffic jam at a position that is distant from the target area by the predetermined distance to the own vehicle side, the vehicle controller is configured to turn on a blinker on a particular section side before the own vehicle reaches the position.
